(19) United States
(12) Patent Application Publication
(10) Pub. No.: US 2013/0088856 A1
(43) Pub. Date: Apr. 11, 2013

(54) TRANSMISSIVE AND REFLECTIVE-MODE CONVERTIBLE DISPLAY

(71) Applicants: Jong-seok KIM, Hwaseong-si (KR); Dong-sik SHIM, Hwaseong-si (KR); Yong-seop YOON, Seoul (KR); Hyung CHOI, Seongnam-si (KR); Woon-bae KIM, Seoul (KR)

(72) Inventors: Jong-seok KIM, Hwaseong-si (KR); Dong-sik SHIM, Hwaseong-si (KR); Yong-seop YOON, Seoul (KR); Hyung CHOI, Seongnam-si (KR); Woon-bae KIM, Seoul (KR)

(73) Assignee: SAMSUNG ELECTRONICS CO., LTD., Suwon-si (KR)

(21) Appl. No.: 13/541,059

(22) Filed: Jul. 3, 2012

(30) Foreign Application Priority Data
Oct. 6, 2011 (KR) 10-2011-0101835

(51) Int. Cl. G09F 13/04

(52) U.S. Cl. 362/97.1

(57) ABSTRACT

A transmissive and reflective mode convertible display is provided including a converting unit convertible between a reflective mirror layer state and a light transmitting layer state and a shutter unit. Based on the state of the converting unit, the display may be drive to utilize light from a backlight transmitted through the converting unit or external light reflected off the converting unit.

### CROSS-REFERENCE TO RELATED APPLICATION

This application claims priority from Korean Patent Application No. 10-2011-0101835, filed on Oct. 06, 2011, in the Korean Intellectual Property Office, the disclosure of which is incorporated herein in its entirety by reference.

### BACKGROUND

1. Field

Apparatuses consistent with exemplary embodiments relate to a display, and more particularly, to a transmissive and reflective-mode convertible display.

2. Description of the Related Art

Displays may be classified into transmissive mode displays and reflective mode displays.

Transmissive mode displays may include a backlight unit having a light source and may externally emit light generated in the light source. A representative example of a transmissive mode display is a liquid crystal display (LCD). An LCD has a fast response speed for realizing an image, has few afterimages, and realizes various colors. However, an LCD has a limited battery lifetime due to display brightness, and has low visibility with respect to sunlight in the outside.

Reflective mode displays display predetermined information while reflecting external light. When a reflective mode display reflects bright light such as sunlight in the outside, the reflective mode display may realize a clear and bright image, and may use small power consumption. However, a reflective mode display has a slow speed in realizing a moving picture and afterimages may be problematic. Also, reflective mode displays have low visibility in dim places without bright and intensive light, and do not realize certain colors.

### SUMMARY

The following an/or other exemplary aspects will be set forth in part in the description which follows and, in part, will be apparent from the description, or may be learned by practice of the presented embodiments.

According to an aspect of an exemplary embodiment, a transmissive and reflective mode convertible display includes a backlight unit comprising a light source; a converting unit formed on the backlight unit, wherein the converting unit is convertible between a reflective mirror layer state and a light-transmitting layer state; a color filter formed on the converting unit; and a shutter unit formed on the color filter.

The backlight unit may include the light source that is a light-emitting diode (LED), a cold cathode fluorescent lamp, or an external electrode fluorescent lamp.

The converting unit may include a lower electrode, and an ion storage layer and an optical switching layer that are formed on the lower electrode.

The converting unit may further include a solid electrolyte layer, a buffer layer, and a catalyst layer that are formed between the ion storage layer and the optical switching layer.

The shutter unit may include a liquid dyed ink structure that utilizes an electrowetting characteristic to shutter light, a micro-electro mechanical systems (MEMS) structure that is electrically switchable between opened and closed states, or a liquid crystal that is convertible between a light-transmitting layer state and an opaque layer state in response to a power applied thereto.

The shutter unit may include a liquid dyed ink structure that includes a first light-transmitting insulating layer; a second light-transmitting insulating layer being separate from the first light-transmitting insulating layer; a separation layer formed between the first light-transmitting insulating layer and the second light-transmitting insulating layer, the separation layer including partition walls and forming a space defined by the partition walls, the first light transmitting layer and the second light transmitting layer; and a shutter member formed in the space.

The shutter member may include a shutter material layer, a top electrode and formed on a top surface of the shutter material layer, and a bottom electrode formed on a bottom surface of the shutter material layer.

The shutter member may include a colored oil.

### BRIEF DESCRIPTION OF THE DRAWINGS

These and/or other exemplary aspects and advantages will become apparent and more readily appreciated from the following description of exemplary embodiments, taken in conjunction with the accompanying drawings in which:

FIG. 1 is a cross-sectional view illustrating a transmissive and reflective-mode convertible display according to an exemplary embodiment;

FIG. 2A is a diagram illustrating a mirror and light-transmitting layer converting unit of the transmissive and reflective-mode convertible display, according to an exemplary embodiment;

FIG. 2B is a diagram illustrating a shutter unit of the transmissive and reflective-mode convertible display, according to an exemplary embodiment;

FIGS. 3A and 3B illustrate an example in which a shutter unit operates when a transmissive and reflective-mode convertible display operates in a transmissive mode, according to an exemplary embodiment; and

FIGS. 4A and 4B illustrate an example in which a shutter unit operates when a transmissive and reflective-mode convertible display operates in a reflective mode, according to an exemplary embodiment.

### DETAILED DESCRIPTION

Reference will now be made in detail to embodiments, examples of which are illustrated in the accompanying drawings. In the drawings, like reference numerals in the drawings denote like elements, and the size or thickness of each component may be exaggerated for clarity.

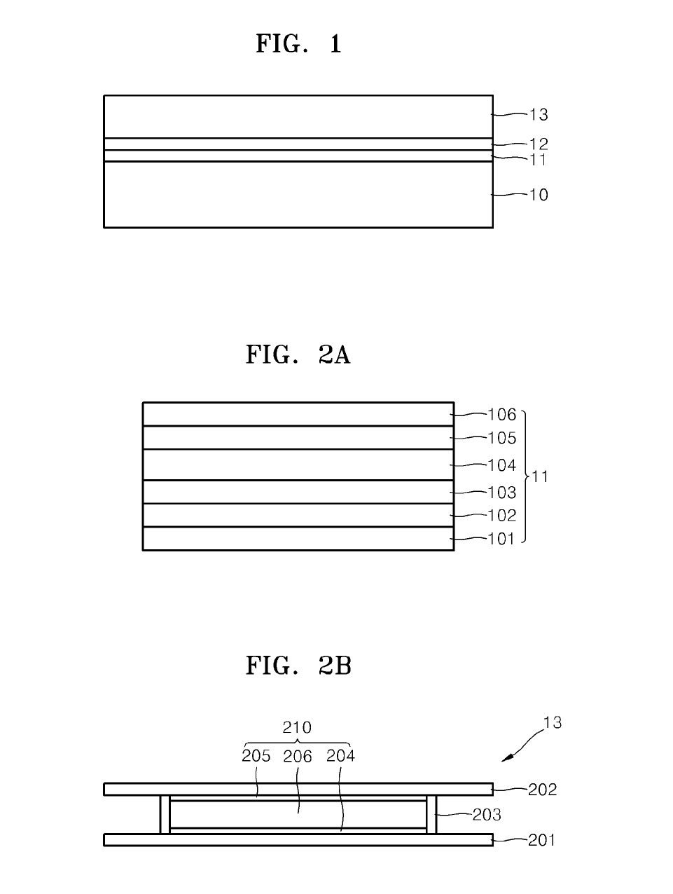

FIG. 1 is a cross-sectional view illustrating a transmissive and reflective-mode convertible display according to an exemplary embodiment.

Referring to FIG. 1, the transmissive and reflective-mode convertible display includes a backlight unit 10 including a light source, a mirror and light-transmitting layer converting unit 11 formed on the backlight unit 10 and selectively convertible between a mirror and a light-transmitting layer, a color filter 12 formed on the mirror and light-transmitting layer converting unit 11 and adding color to light that is received from the backlight unit 10 or an external light source, and a shutter unit 13 formed on the color filter 12 and transmitting or blocking light.

The backlight unit 10 may include a light source and a light guide plate. Examples of the light source include a light-emitting diode (LED), a cold cathode fluorescent lamp, an external electrode fluorescent lamp, or the like but are not limited thereto.

FIG. 2A is a diagram illustrating the mirror and light-transmitting layer converting unit 11 of the transmissive and reflective-mode convertible display, according to an exemplary embodiment.

The mirror and light-transmitting layer converting unit 11 of the transmissive and reflective-mode convertible display may be selectively converted to a mirror or a light-transmitting layer and may be formed of a photochromic glass or a liquid crystal. FIG. 2A illustrates an example of the mirror and light-transmitting layer converting unit 11 that is formed of photochromic glass.

Referring to FIG. 2A, the mirror and light-transmitting layer converting unit 11 may have a structure in which an ion storage layer 102 and an optical switching layer 106 are formed on a lower electrode 101. A solid electrolyte layer 103, a buffer layer 104, and a catalyst layer 105 may be further formed between the ion storage layer 102 and the optical switching layer 106. Materials that form the layers of the mirror and light-transmitting layer converting unit 11 will now be described. For example, the lower electrode 101 may be formed of a transparent and conductive material, e.g., indium tin oxide (ITO). The ion storage layer 102 may be HxWO3(0<x<1); the solid electrolyte layer 103 may be Ta2O3; the buffer layer 104 may be formed of Al; the catalyst layer 105 may be formed of Pd; and the optical switching layer 106 may be formed of Mn—Ni.

Hereinafter, an operational principle of the mirror and light-transmitting layer converting unit 11 will now be described. First, in order to operate the mirror and light-transmitting layer converting unit 11 as the light-transmitting layer, a voltage is applied to the lower electrode 101 and the optical switching layer 106 of the mirror and light-transmitting layer converting unit 11. Here, a negative (−) voltage is applied to the optical switching layer 106, and a positive (+) voltage is applied to the lower electrode 101. By doing so, a hydrogen element of the ion storage layer 102 moves to the optical switching layer 106, is combined with Mg-Ni, and then forms a transparent glass, so that the mirror and light-transmitting layer converting unit 11 may function as the light-transmitting layer. Then, although the applied voltage is removed, the light-transmitting layer converting unit 11 may operate in a light-transmitting layer mode. In order to make the light-transmitting layer converting unit 11 operate in a mirror mode, a positive (+) voltage is applied to the optical switching layer 106, and a negative (−) voltage is applied to the lower electrode 101. By doing so, a hydrogen element of the optical switching layer 106 moves to the lower electrode 101 and then is combined with WO3. The optical switching layer 106 maintains its mirror surface with Mg—Ni, thereby functioning as a mirror.

In a case of the liquid crystal, the mirror and light-transmitting layer converting unit 11 may function as a mirror or a light-transmitting layer according to whether a power is supplied to the liquid crystal. For example, when a voltage is applied to both end terminals of the liquid crystal, the liquid crystal may be converted to a mirror surface, and when a voltage is not applied thereto, the liquid crystal may be transparent.

The color filter 12 may be disposed in units of pixels for displaying an image. When the mirror and light-transmitting layer converting unit 11 is in a mirror mode, the color filter 12 may add colors to reflected light, and when the mirror and light-transmitting layer converting unit 11 is in the light-transmitting layer mode, the color filter 12 may add colors to light received from the backlight unit 10. The color filter 12 may include photosensitive resin composition, and may use red (R), green (G), and blue (B) color filters.

The shutter unit 13 is formed on the color filter 12, and may block or transmit light that is emitted from the backlight unit 10 of the transmissive and reflective-mode convertible display or that is incident on the transmissive and reflective-mode convertible display from an external source. A structure of the shutter unit 13 is not limited provided that the shutter unit 13 selectively blocks or transmits light, and in this regard, examples of the structure of the shutter unit 13 may include a liquid dyed ink structure that has an electrowetting characteristic, a micro-electro mechanical systems (MEMS) structure that is electrically opened or closed, or a liquid crystal that is converted to a light-transmitting layer or an opaque layer in response to a power applied thereto.

FIG. 2B is a diagram illustrating the shutter unit 13 of the transmissive and reflective-mode convertible display, according to an exemplary embodiment. FIG. 2B illustrates the shutter unit 13 having the liquid dyed ink structure.

Referring to FIG. 2B, the shutter unit 13 includes a first light-transmitting insulating layer 201 and a second light-transmitting insulating layer 202 that is separate from the first light-transmitting insulating layer 201, and includes a separation layer 203 having a partition wall structure and formed between the first light-transmitting insulating layer 201 and the second light-transmitting insulating layer 202. A shutter member 210 capable of selectively blocking or transmitting light is formed in a space defined by the first light-transmitting insulating layer 201, the separation layer 203, and the second light-transmitting insulating layer 202.

The first light-transmitting insulating layer 201 and the second light-transmitting insulating layer 202 may be formed of glass, plastic, light-transmitting polymer, or the like. The separation layer 203 may be formed of polymer or glass.

The shutter member 210 may include a shutter material layer 206, and transparent electrodes 204 and 205 may be formed on a top surface and a bottom surface of the shutter material layer 206, respectively. The shutter material layer 206 may include a colored oil. The shutter material layer 206 may be formed of a material having an electrowetting characteristic that is changed to have a hydrophilic characteristic or a hydrophobic characteristic according to an electrical potential difference.

Hereinafter, a method of driving the shutter unit 13 will now be described in detail. When a voltage is applied or is not applied to the transparent electrodes 204 and 205, surface tension of the material included in the shutter material layer 206 is changed so that an area of a contact interface is changed. For example, when an electrical potential difference occurs, the shutter material layer 206 widely spreads, so that light cannot pass through the shutter material layer 206, and when the electrical potential difference is removed, an area of the shutter material layer 206 is decreased, so that light is externally emitted via a region in which the shutter material layer 206 does not exist.

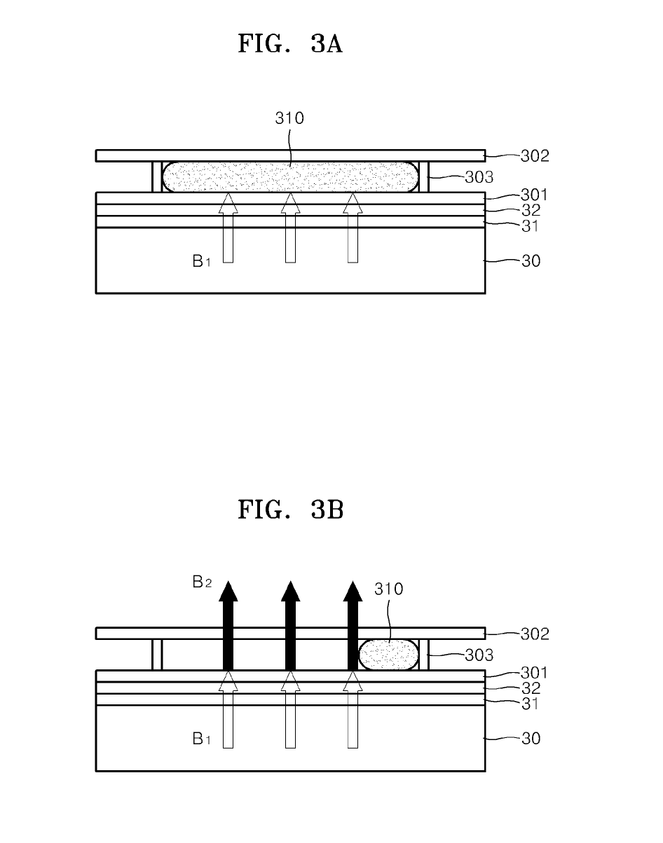

FIGS. 3A and 3B illustrate an example in which a shutter unit operates when a transmissive and reflective-mode convertible display operates in a transmissive mode, according to an embodiment of.

Referring to FIGS. 3A and 3B, the transmissive and reflective-mode convertible display includes a backlight unit 30 including a light source, a mirror and light-transmitting layer converting unit 31, a color filter 32, and the shutter unit formed on the color filter 32.

The shutter unit includes a first light-transmitting insulating layer 301, a second light-transmitting insulating layer 302, and a shutter member 310 between the first light-transmitting insulating layer 301 and the second light-transmitting insulating layer 302. When the transmissive and reflective-mode convertible display operates in the transmissive mode, light from the backlight unit 30 is used, and the mirror and light-transmitting layer converting unit 31 is controlled to function as a light-transmitting layer.

Referring to FIG. 3A, the mirror and light-transmitting layer converting unit 31 is controlled to function as the light-transmitting layer so as to allow light (B1) from the backlight unit 30 to be transmitted. However, currently, the light (B1) from the backlight unit 30 is blocked by the shutter member 310 and thus is not externally emitted from the transmissive and reflective-mode convertible display. In order to externally emit the light (B1) from the backlight unit 30, as illustrated in FIG. 3B, the shutter member 310 is moved by driving the shutter unit. Accordingly, the light (B1) from the backlight unit 30 passes through the color filter 32 and then is externally emitted (B2) from the transmissive and reflective-mode convertible display while the light has a predetermined color.

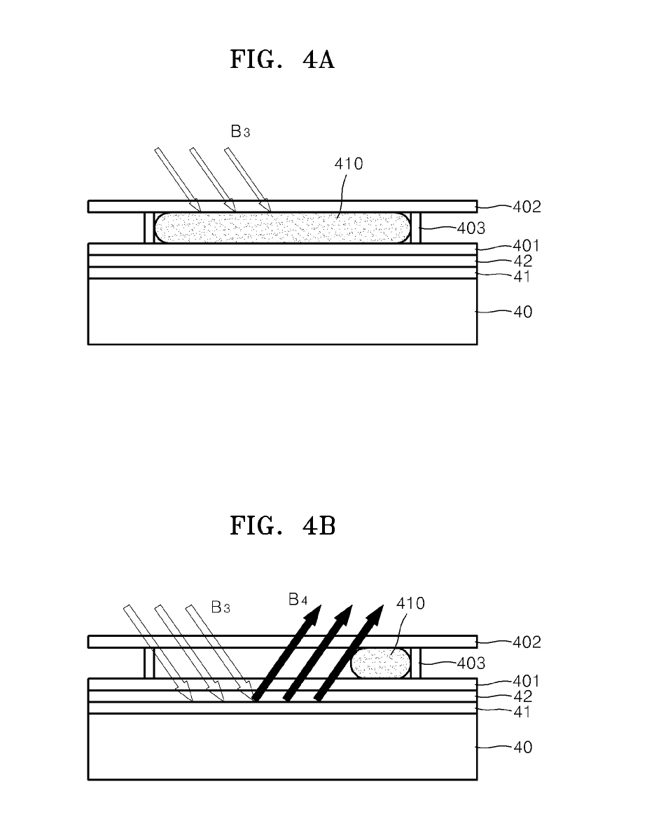

FIGS. 4A and 4B illustrate an example in which a shutter unit operates when a transmissive and reflective-mode convertible display operates in a reflective mode, according to an embodiment of.

Referring to FIGS. 4A and 4B, the transmissive and reflective-mode convertible display includes a backlight unit 40 including a light source, a mirror and light-transmitting layer converting unit 41, a color filter 42, and the shutter unit formed on the color filter 42. The shutter unit may include a first light-transmitting insulating layer 401, a second light-transmitting insulating layer 402, and a shutter member 410 between the first light-transmitting insulating layer 401 and the second light-transmitting insulating layer 402.

When the transmissive and reflective-mode convertible display operates in the reflective mode, light from the backlight unit 40 is not used, so that the backlight unit 40 maintains its off state, and the mirror and light-transmitting layer converting unit 41 is controlled to have a mirror, i.e., a reflective surface.

FIG. 4A illustrates a state in which external light (B3) is blocked with respect to the mirror and light-transmitting layer converting unit 41 and the color filter 42 by the shutter unit, and here, information is not displayed on a surface of the transmissive and reflective-mode convertible display. As illustrated in FIG. 4B, when the shutter member 410 that bocks external light (B3) is moved to a side by driving the shutter unit, external light reaches the color filter 42 and the mirror and light-transmitting layer converting unit 41. Since the mirror and light-transmitting layer converting unit 41 is in a mirror mode, the mirror and light-transmitting layer converting unit 41 reflects external light (B3) and thus external light (B3) is emitted as reflected light B4.

As described above, the transmissive and reflective-mode convertible display according to the one or more embodiments of may select the transmissive mode or the reflective mode and then may operate. For example, in the outside with intensive external light, the transmissive and reflective-mode convertible display may operate in the reflective mode, and in the inside with relatively weak external light, the transmissive and reflective-mode convertible display may operate in the transmissive mode.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A transmissive and reflective mode convertible display comprising:
a backlight unit comprising a light source;
a converting unit disposed on the backlight unit, wherein the converting unit is convertible between a reflective mirror layer state and a light-transmitting layer state;
a color filter disposed on the converting unit; and
a shutter unit disposed on the color filter.

2. The transmissive and reflective mode convertible display of claim 1, wherein the light source comprises a light-emitting diode, a cold cathode fluorescent lamp, or an external electrode fluorescent lamp.

3. The transmissive and reflective mode convertible display of claim 1, wherein the converting unit comprises a lower electrode, an ion storage layer disposed on the lower electrode, and an optical switching layer disposed over the ion storage layer.

4. The transmissive and reflective mode convertible display of claim 3, wherein the converting unit further comprises a solid electrolyte layer, a buffer layer, and a catalyst layer that are disposed between the ion storage layer and the optical switching layer.

5. The transmissive and reflective mode convertible display of claim 3, wherein the ion storage layer is formed of HxWO3.

6. The transmissive and reflective mode convertible display of claim 3, wherein the optical switching layer is formed of Mn—Ni.

7. The transmissive and reflective mode convertible display of claim 1, wherein the shutter unit comprises a liquid dyed ink structure which utilizes an electrowetting characteristic to shutter light, a micro-electro mechanical systems structure that is electrically switchable between opened or closed states, or a liquid crystal that is convertible between a light-transmitting layer state and an opaque layer state in response to a power applied thereto.

8. The transmissive and reflective mode convertible display of claim 1, wherein the shutter unit comprises a liquid dyed ink structure comprising:
a first light-transmitting insulating layer;
a second light-transmitting insulating layer;
a separation layer disposed between the first light-transmitting insulating layer and the second light-transmitting insulating layer, wherein the separation layer comprises partition walls and forms a space defined by the partition walls, the first light transmitting layer, and the second light transmitting layer; and
a shutter member formed in the space.

9. The transmissive and reflective mode convertible display of claim 8, wherein the shutter member comprises a shutter material layer, a top transparent electrode disposed on a top surface of the shutter material layer, and a bottom transparent electrode disposed on a bottom surface of the shutter material layer.

10. The transmissive and reflective-mode convertible display of claim 9, wherein the shutter member comprises a colored oil.

11. A transmissive and reflective mode convertible display comprising:
a backlight unit, a converting unit disposed on the backlight unit, a color filter disposed on the converting unit, and a shutter unit disposed on the color filter;
wherein the converting unit comprises a lower electrode and an optical switching layer and is convertible between a reflective state and a transmissive state by application of a voltage between the lower electrode and the optical switching layer.
